(19) United States
(12) Patent Application Publication
(10) Pub. No.: US 2026/0261548 A1
(43) Pub. Date: Sep. 3, 2026

(54) METHOD FOR SELECTING AUTHENTICATION METHOD AND EDGE SERVER

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/875,564

(22) PCT Filed: Jun. 17, 2022
(86) PCT No.: PCT/CN2022/099603

§ 371 Date: Dec. 16, 2024

(51) Int. Cl. H04L 9/40

(52) U.S. Cl. CPC H04L 63/08; H04L 63/06; H04L 63/166

(57) ABSTRACT

A method for selecting an authentication method, includes: an edge server receiving an authentication method request sent by a terminal, wherein the authentication request request is used for requesting to select any authentication method from n authentication methods; and the edge server sending a first response message to a terminal in response to the authentication method request, wherein the first response message comprises a target authentication method selected from the n authentication methods, and n is a positive integer.

### CROSS-REFERENCE TO RELATED APPLICATIONS

The present application is a U.S. National Stage of International Application No. PCT/CN2022/099603 filed on Jun. 17, 2022, the entire contents of which are incorporated herein by reference for all purposes.

### TECHNICAL FIELD

The present disclosure relates to the field of mobile communications, and in particular, to a method for selecting an authentication method, a device, an apparatus and a storage medium.

### BACKGROUND

In a mobile communication system, authentication is required between a terminal and an edge server, and there are a plurality of authentication methods between the terminal and the edge server. How to select an authentication method between the terminal and the edge server has become a problem that needs to be solved urgently.

### SUMMARY

An aspect of the present disclosure provides a method for selecting an authentication method, which is performed by an edge server, including:
receiving an authentication method request sent by a terminal, the authentication method request being configured to request to select any one authentication method from n authentication methods; and
sending a first response message to the terminal in response to the authentication method request, the first response message including a target authentication method selected from the n authentication methods, n being a positive integer.

An aspect of the present disclosure provides a method for selecting an authentication method, which is performed by a terminal, including:
sending an authentication method request to an edge server, the authentication method request being configured to request the edge server to select any one authentication method from n authentication methods; and
receiving a first response message sent by the edge server, the first response message including a target authentication method selected from the n authentication methods, and the first response message being sent in response to the authentication method request, n being a positive integer.

An aspect of the present disclosure provides a device for selecting an authentication method, including:
a receiving module, configured to receive an authentication method request sent by a terminal, the authentication method request being configured to request to select any one authentication method from n authentication methods; and
a sending module, configured to send a first response message to the terminal in response to the authentication method request, the first response message including a target authentication method selected from the n authentication methods, n being a positive integer.

An aspect of the present disclosure provides a device for selecting an authentication method, including:
a sending module, configured to send an authentication method request to an edge server, the authentication method request being configured to request the edge server to select any one authentication method from n authentication methods; and
a receiving module, configured to receive a first response message sent by the edge server, the first response message including a target authentication method selected from the n authentication methods, and the first response message being sent in response to the authentication method request, n being a positive integer.

An aspect of the present disclosure provides an edge server, including: a processor; a transceiver coupled to the processor; and a memory having executable instructions of the processor stored thereon, wherein the processor is configured to load and execute the executable instructions to implement the method for selecting an authentication method according to the above-described aspect.

An aspect of the present disclosure provides a terminal, including: a processor; a transceiver coupled to the processor; and a memory having executable instructions of the processor stored thereon, wherein the processor is configured to load and execute the executable instructions to implement the method for selecting an authentication method according to the above-described aspect.

An aspect of the present disclosure provides a computer readable storage medium having stored thereon executable program codes that, when being loaded and executed by a processor, implement the method for selecting an authentication method according to the above-described aspect.

An aspect of the present disclosure provides a chip including a programmable logic circuit and/or program codes, and the chip, when running on a terminal or an edge server, implements the method for selecting an authentication method according to the above described aspect.

An aspect of the present disclosure provides a computer program product that, when being executed by a processor of a terminal or an edge server, implements the method for selecting an authentication method according to the above-described aspect.

### BRIEF DESCRIPTION OF THE DRAWINGS

In order to more clearly illustrate the technical solutions in the embodiments of the present disclosure, the accompanying drawings to be used in the description of the embodiments will be briefly described below. Obviously, the accompanying drawings in the following description are only some of the embodiments of the present disclosure, and a person skilled in the art may obtain other accompanying drawings based on the accompanying drawings without creative labor.

FIG. 1 illustrates a block diagram of a communication system provided by an embodiment of the present disclosure;

FIG. 2 illustrates a flowchart of a method for selecting an authentication method provided by an embodiment of the present disclosure;

FIG. 3 illustrates a flowchart of a key authorization method provided by an embodiment of the present disclosure;

FIG. 4 illustrates a flowchart of a key acquisition method provided by an embodiment of the present disclosure;

FIG. 5 illustrates a flowchart of a method for selecting an authentication method provided by an embodiment of the present disclosure;

FIG. 6 illustrates a block diagram of a device for selecting an authentication method provided by an embodiment of the present disclosure;

FIG. 7 illustrates a block diagram of another device for selecting an authentication method provided by an embodiment of the present disclosure;

FIG. 8 illustrates a block diagram of a device for selecting an authentication method provided by an embodiment of the present disclosure; and

FIG. 9 illustrates a schematic structure diagram of a communication device provided by an embodiment of the present disclosure.

### DETAILED DESCRIPTION

In order to make the objects, technical solutions and advantages of the present disclosure clearer, implementations of the present disclosure will be described in further detail below in connection with the accompanying drawings.

Embodiments will be described herein in detail, examples of which are represented in the accompanying drawings. When the following description relates to the accompanying drawings, the same numerals in different accompanying drawings indicate the same or similar elements unless otherwise indicated. The implementations described in the following embodiments do not represent all implementations consistent with the present disclosure. Rather, they are only examples of devices and methods consistent with some aspects of the present disclosure as detailed in the appended claims.

The term used in the present disclosure is used solely for the purpose of describing particular embodiments and is not intended to limit the present disclosure. The singular forms of “a”, “said” “the” used in the present disclosure and the appended claims are also intended to encompass the plural forms, unless clearly indicated otherwise in the context. It is to be also understood that the term “and/or” as used herein refers to and encompasses any or all possible combinations of one or more of the associated listed items.

It is to be understood that while the terms first, second, third, etc. may be used in the present disclosure to describe various types of information, such information should not be limited to these terms. These terms are only used to distinguish the same type of information from one another. For example, without departing from the scope of the present disclosure, first information may also be referred to as second information, and similarly, the second information may be referred to as the first information. Depending on the context, for example, the word “if” as used herein may be interpreted as “at the time of . . . ” or “when . . . ” or “in response to determining”.

It is to be noted that the information (including, but not limited to, user device information, user personal information, etc.), data (including, but not limited to, data used for analysis, data stored, data displayed, etc.), and signals involved in the present disclosure are all authorized by the user or sufficiently authorized by each party, and the collection, use and processing of the relevant data are subject to relevant laws, regulations, and standards of relevant countries and regions.

In the following, an application scenario of the present disclosure is described.

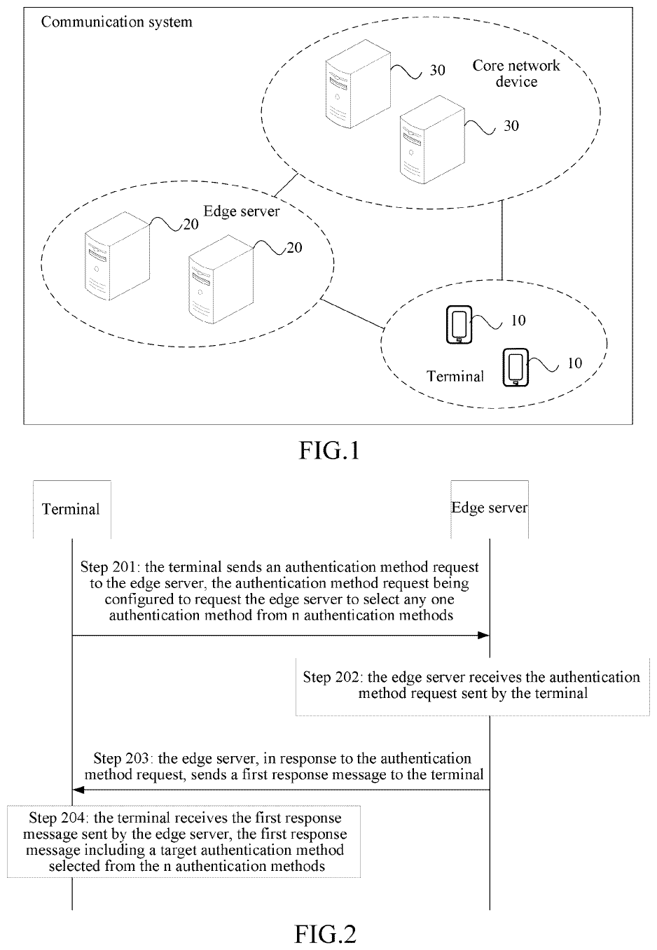

FIG. 1 illustrates a block diagram of a communication system provided by an embodiment of the present disclosure, which may include a terminal 10, an edge server 20, and a core network device 30.

Typically, there are a plurality of terminals 10, and one or more terminals 10 may be distributed within each cell managed by a network device. The terminal 10 may include a variety of handheld devices, in-vehicle devices, wearable devices, computing devices, or other processing devices connected to wireless modems which have wireless communication capabilities, as well as various forms of user equipment (UE), mobile station (MS), and the like. For ease of description, the above-mentioned devices are collectively referred to as terminals in the embodiments of the present disclosure.

The edge server 20 is used to establish wireless communication with the terminal 10 and may provide the terminal 10 with a channel for network services to enable the terminal 10 to communicate with other servers.

In some embodiments, the edge server 20 is either an ECS (edge configuration server) or an EES (edge enabler server).

Authentication is required between the terminal 10 and the edge server 20, and the authentication method to be used may be negotiated between the terminal 10 and the edge server 20.

The core network device 30 may communicate with the edge server 20, and the edge server 20 may authenticate a key corresponding to the selected authentication method to the core network device 30, so that in the case where the key is authenticated successfully, the edge server 20 determines that the selected authentication method is valid, and the edge server 20 and the terminal 10 may determine to use the selected authentication method.

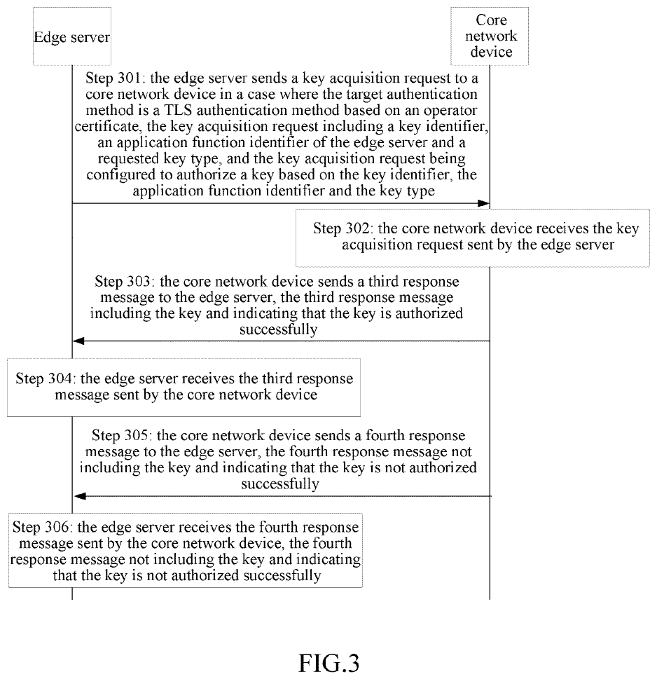

FIG. 2 illustrates a flowchart of a method for selecting an authentication method provided by an embodiment of the present disclosure, which may be exemplarily applied to the terminal and the edge server as shown in FIG. 1, the method including at least some of the followings.

In step 201, a terminal sends an authentication method request to an edge server, the authentication method request being configured to request the edge server to select any one authentication method from n authentication methods.

In some embodiments, the terminal has a plurality of clients installed, and the clients include an EEC (edge enabler client).

In an embodiment, the terminal-installed EEC is applied to an edge computing application architecture, the terminal-installed EEC and the edge server form the edge computing application architecture, and the terminal and the edge server are authenticated to each other using the selected authentication method for the EEC.

In some embodiments, the edge server is an ECS (edge configuration server) or an EES (edge enabler server).

In step 202, the edge server receives the authentication method request sent by the terminal.

The terminal itself supports n authentication methods, and the terminal needs to negotiate with the edge server to determine the selected authentication method so that authentication can be completed between the terminal and the edge server. The n is a positive integer, for example, n is 1, 2, 3, or other values, which is not limited in the embodiments of the present disclosure.

In an embodiment of the present disclosure, the terminal sends the authentication method request to the edge server to inform, through the authentication method request, the edge server of the n authentication methods supported by the terminal, and the edge server, after receiving the authentication method request sent by the terminal, can determine the n authentication methods supported by the terminal, and then can select any one authentication method from the n authentication methods supported by the terminal.

In some embodiments, the authentication method request includes at least one of:
(1) an authentication method identifier, which indicates an authentication method supported by the terminal,
in an embodiment of the present disclosure, the terminal needs to inform the edge server of the authentication methods supported by the terminal, and the terminal may carry, in the authentication method request, the authentication method identifier indicating the authentication method supported by the terminal;
(2) a key type supported by the terminal,
in which the key type indicates a type to which a key that the terminal can generate belongs, for example, the key type is Ks_int_NAF (an kind of key type) or another type, which is not limited in the embodiments of the present disclosure; or
(3) a key identifier,
in which the key identifier indicates a key so as to determine the key indicated by the key identifier.

In some embodiments, the type of authentication method includes at least one of:
(1) an authentication method based on AKMA (authentication and key management for applications) with TLS (transport layer security),
in which there are a plurality of authentication methods based on AKMA with TLS, for example, the authentication method based on AKMA with TLS includes an authentication method 1, an authentication method 2, and an authentication method 3, that is, the authentication method 1, authentication method 2, and authentication method 3 all belong to the authentication method based on AKMA with TLS; or
(2) an authentication method based on GBA (general bootstrapping architecture) with TLS,
in which there are a plurality of authentication methods based on GBA with TLS, for example, the authentication method based on GBA with TLS includes an authentication method 4, an authentication method 5, and an authentication method 6, that is, the authentication method 4, authentication method 5, and authentication method 6 all belong to the authentication method based on GBA with TLS.

It is to be noted that the embodiments of the present disclosure illustrate as an example that the type of authentication method includes the authentication method based on AKMA or GBA with TLS. In another embodiment, the type of authentication method may also be an authentication method based on a client certificate with TLS.

In step 203, the edge server, in response to the authentication method request, sends a first response message to the terminal.

In step 204, the terminal receives the first response message sent by the edge server, the first response message including a target authentication method selected from the n authentication methods.

In an embodiment of the present disclosure, the edge server, after receiving the authentication method request sent by the terminal, may select the target authentication method from the n authentication methods included in the authentication method request, and then may send, in response to the authentication method request, the first response message including the target authentication method to the terminal, and the terminal, after receiving the first response message, can determine the target authentication method selected by the edge server from the n authentication methods.

It is to be noted that the steps performed by the terminal in the embodiment of the present disclosure may separately form a new embodiment, and the steps performed by the edge server may also separately form a new embodiment.

It is to be noted that the embodiments of the present disclosure illustrate as an example that the edge server determines the target authentication method. In another embodiment, the edge server may not determine the target authentication method.

In an embodiment of the present disclosure, if the edge server does not support the authentication method supported by the terminal, the edge server sends an error message to the terminal to inform that there is no authentication method to be commonly used between the edge server and the terminal.

That is, the authentication methods supported by the edge server are different from the authentication methods supported by the terminal, so that the edge server and the terminal may not use a same authentication method, and therefore the edge server sends the error message to the terminal.

In the solution of the embodiments of the present disclosure, the edge server determines the target authentication method from a plurality of authentication methods based on the authentication method request sent by the terminal, and informs the terminal of the target authentication method selected for use, which provides a solution for selecting an authentication method to be used from a plurality of authentication methods, ensuring that an authentication method to be used commonly can be determined between the terminal and the edge server, and thereby ensuring the reliability of the selected authentication method.

The embodiment shown in FIG. 2 illustrates how the edge server may select the target authentication method from the n authentication methods. In the following, it illustrates how the edge server specifically determines the target authentication method.

In some embodiments, the edge server determines the target authentication method from the n authentication methods based on an authentication method supported by that edge server and an authentication selection policy.

The authentication selection policy is a policy by which the edge server determines the target authentication method from the n authentication methods. The authentication selection policy is a policy that has been configured by the edge server. Further, the edge server has an authentication method supported.

In an embodiment of the present disclosure, the edge server may determine the target authentication method from the n authentication methods based on the authentication method supported by itself and the authentication selection policy.

In some embodiments, the edge server determines m authentication methods among the n authentication methods based on a key type and the authentication method supported by the edge server, the m authentication methods matching the key type and the authentication method supported by the edge server, m being a positive integer not greater than n; and determines, based on the authentication selection policy, the authentication method with a highest priority among the matched m authentication methods as the target authentication method.

In an embodiment of the present disclosure, the edge server knows the key type and the authentication method supported by itself, and also knows the key type and the n authentication methods supported by the terminal, then the edge server may determine the m authentication methods among the n authentication methods that match the key type and the authentication method supported by the edge server. Each authentication method correspondingly has a priority, and then the edge server determines, based on the authentication selection policy, the authentication method with the highest priority among the m authentication methods as the target authentication method.

For example, if the matched m authentication methods determined include an authentication method 1, an authentication method 2, and an authentication method 3, and the priorities of the authentication method 1, authentication method 2, and authentication method 3decrease in order, the authentication method 1 is determined as the target authentication method.

In the solution provided by the embodiments of the present disclosure, the edge server can determine the target authentication method from the n authentication methods according to the authentication method supported by itself and the authentication selection policy. As it considers the authentication method supported by the edge server and the authentication selection policy, the accuracy of the selected target authentication method may be improved.

On the basis of the above embodiment, after the edge server determines the target authentication method, if the target authentication method is a TLS authentication method based on an operator certificate, it may also authorize a key corresponding to the target authentication method. FIG. 3 illustrates a flowchart of a key authorization method provided by an embodiment of the present disclosure. As shown in FIG. 3, the method includes the followings.

In step 301, the edge server sends a key acquisition request to a core network device in a case where the target authentication method is a TLS authentication method based on an operator certificate. The key acquisition request includes a key identifier, an application function identifier of the edge server and a requested key type, and the key acquisition request is configured to authorize a key based on the key identifier, the application function identifier and the key type. The application function identifier includes, but is not limited to, AF-ID (application function identifier) in the AKMA scenario and NAF-Id (network application function identifier) in the GBA scenario.

In step 302, the core network device receives the key acquisition request from the edge server.

The application function identifier of the edge server indicates the application function of the edge server to inform the core network device of the application function of the edge server, and the core network device may also determine, based on the application function identifier, whether the edge server has the authority to obtain the key.

If the application function identifier sent by the edge server is not stored in the core network device, it indicates that the edge server does not have the authority to obtain the key at this time, and if the core network device stores the application function identifier sent by the edge server, it determines that the edge server has the authority to obtain the key.

In addition, the TLS authentication method based on the operator certificate requires the core network device to authorize the key. The TLS authentication method based on the operator certificate includes an authentication method based on AKMA with TLS, or includes an authentication method based on GBA with TLS, or include other authentication methods, which is not limited by the embodiments of the present disclosure.

In the embodiment of the present disclosure, after the edge server determines the target authentication method, if the target authentication method is the TLS authentication method based on the operator certificate, then the edge server needs to authenticate the key corresponding to the target authentication method in order to obtain authorization of the core network device for the key. The edge server sends the key acquisition request to the core network device, and includes, in the key acquisition request, the key identifier, the application function identifier of the edge server, and the requested key type, then the core network device, after receiving the key acquisition request, may authorize the key according to the key identifier, the application function identifier of the edge server, and the requested key type.

In step 303, the core network device sends a third response message to the edge server. The third response message includes the key and indicates that the key is authorized successfully.

In step 304, the edge server receives the third response message sent by the core network device.

The third response message includes the key, which means that the third response message indicates that the key is authorized successfully.

In the embodiment of the present disclosure, after receiving the key acquisition request sent by the edge server, if the core network device may determine, based on the application function identifier, that the edge server has the authority to acquire the key, and may determine a corresponding key based on the key identifier, then the core network may carry the key in the third response message, and send the third response message to the edge server. Then the edge server may receive the third response message.

In step 305, the core network device sends a fourth response message to the edge server. The fourth response message does not include the key and indicates that the key is not authorized successfully.

In step 306, the edge server receives the fourth response message sent by the core network device. The fourth response message does not include the key and indicates that the key is not authorized successfully.

The fourth response message does not include the key, which means that the fourth response message indicates that the key is not authorized successfully.

In the embodiment of the present disclosure, after receiving the key acquisition request sent by the edge server, if the core network device may determine, based on the application function identifier, that the edge server does not have the authority to acquire the key, and/or cannot determine a corresponding key based on the key identifier, then the core network device may not carry the key in the fourth response message, and send the fourth response message to the edge server. Then the edge server may receive the fourth response message.

It is to be noted that steps 303-304 and steps 305-306 are parallel solutions, so that if steps 303-304 are executed in the present disclosure, steps 305-306 may not be executed, and if steps 305-306 are executed in the present disclosure, steps 303-304 may not be executed.

In the solution provided by the embodiment of the present disclosure, the edge server sends the key acquisition request to the core network device to instruct the core network device to authorize the key, and the core network device may determine, based on the key acquisition request, whether the key can be authorized, to ensure the accuracy of the key authorization, and thus the accuracy of the selection of the authentication method.

It is to be noted that the embodiment of the present disclosure illustrates as an example that steps 305-306 determine that the key is not authorized successfully. Further, the edge server may also re-determine the target authentication method, and in the case where the re-determined target authentication method is the TLS authentication method based on the operator certificate, the edge server may re-send the key acquisition request to the core network device to authorize the key.

In some embodiments, the edge server, upon determining that the key is not authorized successfully and there exists unused other authentication methods than the target authentication method among the n authentication methods, determines x authentication methods among the other authentication methods based on a key type and the authentication method supported by the edge server, the x authentication methods matching the key type and the authentication method supported by the edge server, and x being a positive integer less than n; re-determines, based on the authentication selection policy, the authentication method with a highest priority among the matched x authentication methods as the target authentication method; and re-performs the step of sending the key acquisition request to the core network device in the case where the target authentication method is the TLS authentication method based on the operator certificate.

In an embodiment of the present disclosure, if the edge server determines that the key corresponding to the target authentication method is not authorized successfully, and that there exists unused other authentication methods than the target authentication method among the n authentication methods, the edge server may continue to determine x authentication methods among the other authentication methods based on the key type and the authentication method supported by the edge server, the x authentication methods matching the key type and the authentication method supported by the edge server, and x being a positive integer less than n; re-determines the authentication method with a highest priority among the determined x authentication methods as the target authentication method; and continues to perform the step of sending the key acquisition request to the core network device if the target authentication method is the TLS authentication method based on the operator certificate, so as to determine whether the key is authorized successfully or not.

It is to be noted that if the key is authorized successfully, the edge server performs the above step 203 to inform the terminal of the selected target authentication method, and if the edge server determines that the key corresponding to the re-determined target authentication method still has not been authorized successfully, it continues to re-determine the target authentication method, and then continues to perform the step of sending the key acquisition request to the core network until it is determined that the key is authorized successfully.

For example, the authentication method request sent by the terminal to the edge server includes an authentication method 1, an authentication method 2, an authentication method 3, and an authentication method 4, and the edge server determines that the matching authentication methods among the four authentication methods are the authentication method 1, the authentication method 2, and the authentication method 4, and that the levels of the priorities of the authentication method 1, the authentication method 2, and the authentication method 4 are decreased in order. Then the edge server first determines the authentication method 1 as the target authentication method. The authentication method 1 is the TLS authentication method based on the operator certificate, so the edge server confirms with the core network device whether the key of the authentication method 1 is successfully authorized. If the authorization is successful, the edge server sends the authentication method 1 to the terminal, and if the authorization is unsuccessful, then the edge server re-determines the authentication method 2. The authentication method 2 is the TLS authentication method based on the operator certificate, so the edge server confirms with the core network device whether the key of the authentication method 2 is successfully authorized. If the authorization is successful, the edge server sends the authentication method 2 to the terminal, and if the authorization is unsuccessful, the edge server re-determines the authentication method 4. The authentication method 4 is the TLS authentication method based on the operator certificate, so the edge server confirms with the core network device whether the key of the authentication method 4 is successfully authorized. If the authorization is successful, the edge server sends the authentication method 4 to the terminal, and if the authorization is unsuccessful, then the edge server sends an error message to the terminal.

In some embodiments, the edge server sends an error message to the terminal sending an error message to the terminal if it determines that the key is not authorized successfully and there exists no unused other authentication methods than the target authentication method among the n authentication methods.

The error message indicates that the edge server has not selected an authentication method to be commonly used with the terminal, and the edge server and the terminal end the procedure of selecting the authentication method therebetween.

In some embodiments, if the edge server determines that the target authentication method is the TLS authentication method based on the operator certificate, and the authentication method request does not yet include a key identifier, the edge server may first obtain the key identifier from the terminal.

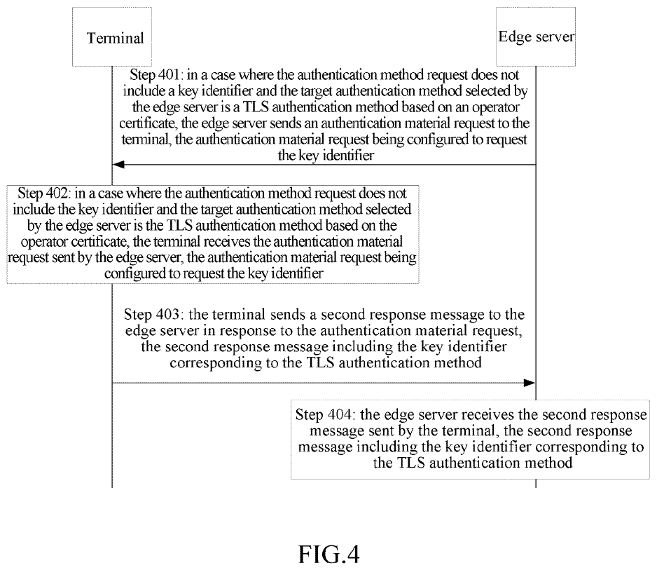

FIG. 4 illustrates a flowchart of a key acquisition method provided by an embodiment of the present disclosure. Referring to FIG. 4, the key acquisition method includes the followings.

In step 401, in a case where the authentication method request does not include a key identifier and the target authentication method selected by the edge server is a TLS authentication method based on an operator certificate, the edge server sends an authentication material request to the terminal, the authentication material request being configured to request the key identifier.

In step 402, in a case where the authentication method request does not include the key identifier and the target authentication method selected by the edge server is the TLS authentication method based on the operator certificate, the terminal receives the authentication material request sent by the edge server, the authentication material request being configured to request the key identifier.

In an embodiment of the present disclosure, if the target authentication method selected by the edge server is the TLS authentication method based on the operator certificate, the edge server may acquire, based on the key identifier sent by the terminal, authorization of the key corresponding to the key identifier from the core network device, and if the terminal does not send the key identifier to the edge server via the authentication method request, the edge server may acquire the key identifier from the terminal.

In an embodiment of the present disclosure, if the edge server determines that the target authentication method is the TLS authentication method based on the operator certificate, and the terminal does not report the key identifier through the authentication method request, the edge server sends the authentication material request to the terminal, and the terminal, upon receiving the authentication material request, may determine that the edge server needs the terminal to report the key identifier.

In some embodiments, the authentication material request includes an authentication method identifier of the target authentication method selected by the edge server, and thus the terminal may determine the key identifier corresponding to the authentication method required by the edge server based on the authentication method identifier.

In an embodiment, the key identifier includes an A-KID (AKMA key identifier), a B-TID (bootstrapping transaction identifier), or other types of identifiers, which is not limited by the embodiments of the present disclosure.

For example, if the key identifier is A-KID, the authentication method corresponding to the key identifier is an authentication method based on AKMA with TLS. If the key identification is B-TID, the authentication method corresponding to the key identifier is an authentication method based on GBA with TLS.

In step 403, the terminal sends a second response message to the edge server in response to the authentication material request, the second response message including the key identifier corresponding to the TLS authentication method.

In step 404, the edge server receives the second response message sent by the terminal, the second response message including the key identifier corresponding to the TLS authentication method.

In the embodiment of the present disclosure, after receiving the authentication material request, the terminal may determine the key identifier required by the edge server based on the authentication material request, and in response to the authentication material request, sends to the edge server the second response message carrying the key identifier corresponding to the TLS authentication method, and the edge server receives the second response message sent by the terminal.

For example, if the target authentication method selected by the edge server is the authentication method based on AKMA with TLS, the terminal returns to the edge server the A-KID corresponding to AKMA, and if the target authentication method selected by the edge server is the authentication method based on GBA with TLS, the terminal returns to the edge server the B-TID corresponding to GBA.

In the solution provided by the embodiment of the present disclosure, if the target authentication method determined by the edge server is the TLS authentication method based on the operator certificate, the edge server may confirm with the core network device the authorization of the key, and determine whether the core network device has successfully authorized the key based on whether the key is carried in the response message fed back by the core network, so as to ensure the reliability of the authorization.

It is to be noted that the embodiment of the present disclosure illustrates an example in which the edge server interacts with the core network device to complete the authorization of a key. In another embodiment, the core network device includes a plurality of types of network elements. For example, the core network device includes an AAnF (AKMA anchor function) network element, a BSF (bootstrapping server function) network element or a Zn-proxy (a proxy function) network element.

In the following, the interacting between the core network device and the edge server in steps 301-306 involved in the embodiments of the present disclosure is described in detail.

In some embodiments, if the edge server determines that the target authentication method is the authentication method based on AKMA with TLS, the edge server determines that the key for this authentication method needs to be authorized by the AAnF network element, and therefore the edge server sends a key acquisition request to the AAnF network element, and the AAnF network element sends a response message to the edge server in response to the key acquisition request.

In some other embodiments, if the edge server determines that the target authentication method is the authentication method based on GBA with TLS, the edge server determines that the key for this authentication method needs to be authorized by the BSF network element, and therefore the edge server sends a key acquisition request to the BSF network element, and the BSF network element sends a response message to the edge server in response to the key obtaining request.

It is to be noted that in an embodiment of the present disclosure, if the terminal is not in a roaming area, the edge server may directly send the key acquisition request to the BSF network element. In another embodiment, the terminal may be in a roaming area, in which case the edge server does not directly send the key acquisition request to the BSF network element, but first sends the key acquisition request to the Zn-proxy network element, and then the Zn-proxy network element sends the key acquisition request to the BSF network element, and the BSF network element and/or the Zn-proxy performs the key authorization step.

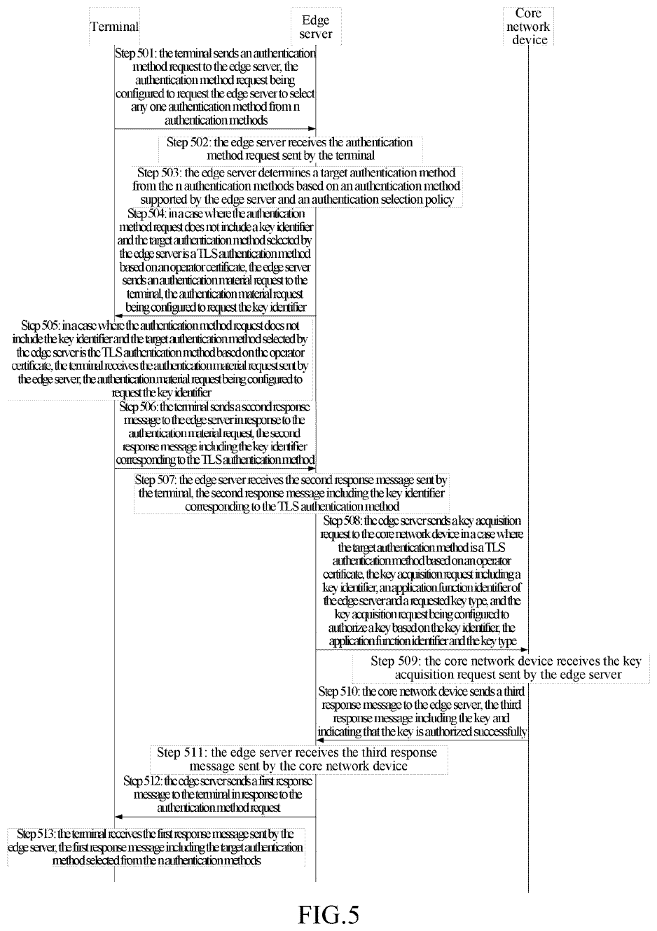

In the following, the method for selecting an authentication method in the present disclosure is illustrated by referring to the example of FIG. 5 in conjunction with the embodiments of FIGS. 2, 3, and 4. FIG. 5 illustrates a flowchart of a method for selecting an authentication method provided by an embodiment of the present disclosure. As shown in FIG. 5, the method includes the followings.

In step 501, a terminal sends an authentication method request to an edge server, the authentication method request being configured to request the edge server to select any one authentication method from n authentication methods.

In step 502, the edge server receives the authentication method request sent by the terminal.

In step 503, the edge server determines a target authentication method from the n authentication methods based on an authentication method supported by the edge server and an authentication selection policy.

Steps 501-503 are similar to steps 201-202 described above, which are not repeated herein.

In step 504, in a case where the authentication method request does not include a key identifier and the target authentication method selected by the edge server is a TLS authentication method based on an operator certificate, the edge server sends an authentication material request to the terminal, the authentication material request being configured to request the key identifier.

In step 505, in a case where the authentication method request does not include the key identifier and the target authentication method selected by the edge server is the TLS authentication method based on the operator certificate, the terminal receives the authentication material request sent by the edge server, the authentication material request being configured to request the key identifier.

In step 506, the terminal sends a second response message to the edge server in response to the authentication material request, the second response message including the key identifier corresponding to the TLS authentication method.

In step 507, the edge server receives the second response message sent by the terminal, the second response message including the key identifier corresponding to the TLS authentication method.

Steps 504-507 are similar to steps 401-404 described above, which will not be repeated herein.

In step 508, the edge server sends a key acquisition request to a core network device in a case where the target authentication method is a TLS authentication method based on an operator certificate, the key acquisition request including a key identifier, an application function identifier of the edge server and a requested key type, and the key acquisition request being configured to authorize a key based on the key identifier, the application function identifier and the key type.

In step 509, the core network device receives the key acquisition request sent by the edge server.

In step 510, the core network device sends a third response message to the edge server, the third response message including the key and indicating that the key is authorized successfully.

In step 511, the edge server receives the third response message sent by the core network device.

Steps 508-511 are similar to steps 301-304 described above, which will not be repeated herein.

In step 512, the edge server sends a first response message to the terminal in response to the authentication method request.

In step 513, the terminal receives the first response message sent by the edge server, the first response message including the target authentication method selected from the n authentication methods.

Steps 512-513 are similar to steps 203-204 described above, which will not be repeated herein.

It is to be noted that the above embodiment may be split into new embodiments or combine with another embodiment into a new embodiment, and the present disclosure does not limit the combination between embodiments.

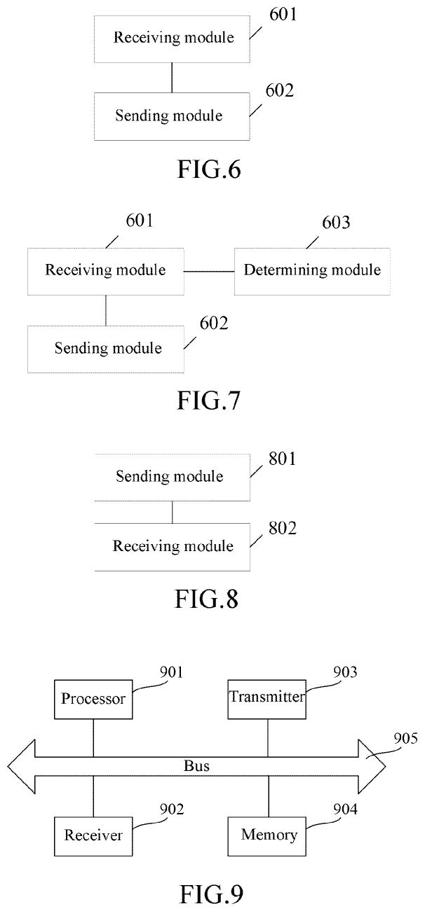

FIG. 6 illustrates a block diagram of a device for selecting an authentication method provided by an embodiment of the present disclosure. Referring to FIG. 6, the device includes:
a receiving module 601, configured to receive an authentication method request sent by a terminal, the authentication method request being configured to request to select any one authentication method from n authentication methods; and
a sending module 602, configured to send a first response message to the terminal in response to the authentication method request, the first response message including a target authentication method selected from the n authentication methods, n being a positive integer.

In some embodiments, the authentication method request includes at least one of:
an authentication method identifier, the authentication method identifier indicating an authentication method supported by the terminal;
a key type supported by the terminal; or
a key identifier.

In some embodiments, a type of the authentication method includes at least one of:
an authentication method based on AKMA with TLS; or
an authentication method based on GBA with TLS.

In some embodiments, referring to FIG. 7, the device further includes:
a determining module 603, configured to determine the target authentication method from the n authentication methods based on an authentication method supported by the edge server and an authentication selection policy.

In some embodiments, the determining module 603 is further configured to:
determine m authentication methods among the n authentication methods based on a key type and the authentication method supported by the edge server, the m authentication methods matching the key type and the authentication method supported by the edge server, m being a positive integer not greater than n; and
determine, based on the authentication selection policy, the authentication method with a highest priority among the matched m authentication methods as the target authentication method.

In some embodiments, the sending module 602 is further configured to: send a key acquisition request to a core network device in a case where the target authentication method is a TLS authentication method based on an operator certificate, the key acquisition request including a key identifier, an application function identifier of the edge server and a requested key type, and the key acquisition request being configured to authorize a key based on the key identifier, the application function identifier and the key type.

In some embodiments, the receiving module 601 is further configured to: receive a third response message sent by the core network device, the third response message including the key and indicating that the key is authorized successfully.

In some embodiments, the receiving module 601 is further configured to: receive a fourth response message sent by the core network device, the fourth response message not including the key and indicating that the key is not authorized successfully.

In some embodiments, the determining module 603 is configured to, in a case where the key is not authorized successfully and there exists unused other authentication methods than the target authentication method among the n authentication methods, determine x authentication methods among the other authentication methods based on a key type and the authentication method supported by the edge server, the x authentication methods matching the key type and the authentication method supported by the edge server, and x being a positive integer less than n;
the determining module 603 is further configured to re-determine, based on the authentication selection policy, the authentication method with a highest priority among the matched x authentication methods as the target authentication method; and
the sending module 602 is further configured to re-perform the step of sending the key acquisition request to the core network device in the case where the target authentication method is the TLS authentication method based on the operator certificate.

In some embodiments, the sending module 602 is further configured to, in a case where the authentication method request does not include a key identifier and the target authentication method selected by the edge server is a TLS authentication method based on an operator certificate, send an authentication material request to the terminal, the authentication material request being configured to request the key identifier; and
the receiving module 601 is further configured to receive a second response message sent by the terminal, the second response message including a key identifier corresponding to the TLS authentication method.

In some embodiments, the sending module 602 is further configured to: send an error message to the terminal in a case where the key is not authorized successfully and there exists no unused other authentication methods than the target authentication method among the n authentication methods.

In some embodiments, the sending module 602 is further configured to: send an error message to the terminal in a case where the edge server does not support an authentication method supported by the terminal.

In some embodiments, the terminal is an EEC.

In some embodiments, the edge server is an ECS or an EES.

It is to be noted that the device provided in the above embodiments is only illustrated by the division of the above-described respective functional modules when realizing its function, and in actual application, the above-described function may be assigned to be completed by different functional modules according to the needs, i.e., the internal structure of the device may be divided into different functional modules in order to complete all or part of the above-described function. In addition, the device provided in the above embodiments belongs to the same concept as the method embodiments, and the specific implementation thereof is described in details in the method embodiments, which will not be repeated here.

FIG. 8 illustrates a block diagram of a device for selecting an authentication method provided by an embodiment of the present disclosure. Referring to FIG. 8, the device includes:
a sending module 801, configured to send an authentication method request to an edge server, the authentication method request being configured to request the edge server to select any one authentication method from n authentication methods; and
a receiving module 802, configured to receive a first response message sent by the edge server, the first response message including a target authentication method selected from the n authentication methods, and the first response message being sent in response to the authentication method request, n being a positive integer.

In some embodiments, the authentication method request includes at least one of:
an authentication method identifier, the authentication method identifier indicating an authentication method supported by the terminal;
a key type supported by the terminal; or
a key identifier.

In some embodiments, a type of the authentication method includes at least one of:
an authentication method based on AKMA with TLS; or
an authentication method based on GBA with TLS.

In some embodiments, the receiving module 802 is configured to, in a case where the authentication method request does not include a key identifier and the target authentication method selected by the edge server is a TLS authentication method based on an operator certificate, receive an authentication material request sent by the edge server, the authentication material request being configured to request the key identifier; and
the sending module 801 is configured to send a second response message to the edge server in response to the authentication material request, the second response message including a key identifier corresponding to the TLS authentication method.

In some embodiments, the receiving module 802 is configured to: receive an error message sent by the edge server in a case where the edge server does not support an authentication method supported by the terminal.

In some embodiments, the terminal is an EEC.

In some embodiments, the edge server is an ECS or an EES.

It is to be noted that the device provided in the above embodiments is only illustrated by the division of the above-described respective functional modules when realizing its function, and in actual application, the above-described function may be assigned to be completed by different functional modules according to the needs, i.e., the internal structure of the device may be divided into different functional modules in order to complete all or part of the above-described function. In addition, the device provided in the above embodiments belongs to the same concept as the method embodiments, and the specific implementation thereof is described in details in the method embodiments, which will not be repeated here.

FIG. 9 illustrates a schematic structure diagram of a communication device provided by an embodiment of the present disclosure. The communication device includes a processor 901, a receiver 902, a transmitter 903, a memory 904, and a bus 905.

The processor 901 includes one or more processing cores, and the processor 901 performs various functional applications and information processing by running software programs and modules.

The receiver 902 and the transmitter 903 may be implemented as one communication component, which may be a communication chip.

The memory 904 is connected to the processor 901 via the bus 905.

The memory 904 may be used to store at least one program code, and the processor 901 is used to execute the at least one program code to implement the various steps in the method embodiment described above.

In addition, the communication device may be a terminal or an edge server. The memory 904 may be implemented by any type of volatile or non-volatile storage device or a combination thereof, and the volatile or non-volatile storage device include, but is not limited to: magnetic or optical discs, electrically erasable programmable read-only memory (EEPROM), erasable programmable read-only memory (EPROM), static random access memory (SRAM), read-only memory (ROM), magnetic memory, flash memory, and programmable read-only memory (PROM).

An embodiment further provides a computer readable storage medium having stored thereon executable program codes that, when being loaded and executed by a processor, implement the method for selecting an authentication method performed by a communication device provided by the above various method embodiments.

An embodiment provides a chip including a programmable logic circuit and/or program codes, and the chip, when running on a terminal or an edge server, implements the method for selecting an authentication method provided by the above various method embodiments.

An embodiment provides a computer program product that, when being executed by a processor of a terminal or an edge server, implements the method for selecting an authentication method provided by the above various method embodiments.

A person skilled in the art may understand that all or some of the steps for implementing the above embodiments may be accomplished by hardware, or may be accomplished by a program instructing relevant hardware, the program may be stored in a computer-readable storage medium, and the storage medium describe above may be a read-only memory, a magnetic disc, a compact disc, and the like.

The above descriptions are only optional embodiments of the present disclosure, and are not intended to limit the present disclosure, and any modifications, equivalent replacements, improvements or the like made within the spirit and principle of the present disclosure shall be included in the protection scope of the present disclosure.

1. A method for selecting an authentication method, which is performed by an edge server, comprising:
receiving an authentication method request sent by a terminal, the authentication method request being configured to request to select any one authentication method from n authentication methods; and
sending a first response message to the terminal in response to the authentication method request, the first response message comprising a target authentication method selected from the n authentication methods, n being a positive integer.

2. The method according to claim 1, wherein the authentication method request comprises at least one of:
an authentication method identifier, the authentication method identifier indicating an authentication method supported by the terminal;
a key type supported by the terminal; or
a key identifier.

3. The method according to claim 1, wherein a type of the authentication method comprises at least one of:
an authentication method based on authentication and key management for applications (AKMA) with transport layer security (TLS); or
an authentication method based on general bootstrapping architecture (GBA) with TLS.

4. The method according to claim 1, further comprising:
determining the target authentication method from the n authentication methods based on an authentication method supported by the edge server and an authentication selection policy.

5. The method according to claim 4, wherein determining the target authentication method from the n authentication methods based on the authentication method supported by the edge server and the authentication selection policy comprises:
determining m authentication methods among the n authentication methods based on a key type and the authentication method supported by the edge server, the m authentication methods matching the key type and the authentication method supported by the edge server, m being a positive integer not greater than n; and
determining, based on the authentication selection policy, the authentication method with a highest priority among the matched m authentication methods as the target authentication method.

6. The method according to claim 4, wherein the target authentication method is a TLS authentication method based on an operator certificate, and the method further comprises:
sending a key acquisition request to a core network device, the key acquisition request comprising a key identifier, an application function identifier of the edge server and a requested key type, and the key acquisition request being configured to authorize a key based on the key identifier, the application function identifier and the key type.

7. The method according to claim 6, further comprising:
receiving a third response message sent by the core network device, the third response message comprising the key and indicating that the key is authorized successfully.

8. The method according to claim 6, further comprising:
receiving a fourth response message sent by the core network device, the fourth response message not comprising the key and indicating that the key is not authorized successfully.

9. The method according to claim 8, wherein the key is not authorized successfully and there exists unused other authentication methods than the target authentication method among the n authentication methods, and the method further comprises:
determining x authentication methods among the other authentication methods based on a key type and the authentication method supported by the edge server, the x authentication methods matching the key type and the authentication method supported by the edge server, and x being a positive integer less than n;
re-determining, based on the authentication selection policy, the authentication method with a highest priority among the matched x authentication methods as the target authentication method; and
re-performing the step of sending the key acquisition request to the core network device in the case where the target authentication method is the TLS authentication method based on the operator certificate.

10. The method according to claim 4, wherein the authentication method request does not comprise a key identifier and the target authentication method selected by the edge server is a TLS authentication method based on an operator certificate, and the method further comprises:
sending an authentication material request to the terminal, the authentication material request being configured to request the key identifier; and
receiving a second response message sent by the terminal, the second response message comprising a key identifier corresponding to the TLS authentication method.

11. The method according to claim 9, wherein the key is not authorized successfully and there exists no unused other authentication methods than the target authentication method among the n authentication methods, and the method further comprises:
sending an error message to the terminal.

12. The method according to claim 1, wherein the edge server does not support an authentication method supported by the terminal, and the method further comprises:
sending an error message to the terminal.

13. The method according to claim 1, wherein the terminal is an edge enabler client (EEC), and the edge server is an edge configuration server (ECS) or an edge enabler server (EES).

14. (canceled)

15. A method for selecting an authentication method, which is performed by a terminal, comprising:
sending an authentication method request to an edge server, the authentication method request being configured to request the edge server to select any one authentication method from n authentication methods; and
receiving a first response message sent by the edge server, the first response message comprising a target authentication method selected from the n authentication methods, and the first response message being sent in response to the authentication method request, n being a positive integer.

16. The method according to claim 15, wherein the authentication method request comprises at least one of:
an authentication method identifier, the authentication method identifier indicating an authentication method supported by the terminal;
a key type supported by the terminal; or
a key identifier.

17. The method according to claim 15, wherein a type of the authentication method comprises at least one of:
an authentication method based on AKMA with TLS; or an authentication method based on GBA with TLS.

18. The method according to claim 15, wherein the authentication method request does not comprise a key identifier and the target authentication method selected by the edge server is a TLS authentication method based on an operator certificate, and the method further comprises:
receiving an authentication material request sent by the edge server, the authentication material request being configured to request the key identifier; and
sending a second response message to the edge server in response to the authentication material request, the second response message comprising a key identifier corresponding to the TLS authentication method.

19. The method according to claim 15, wherein the edge server does not support an authentication method supported by the terminal, and the method further comprises:
receiving an error message sent by the edge server.

20. The method according to claim 15, wherein the terminal is an edge enabler client (EEC), and the edge server is an edge configuration server (ECS) or an edge enabler server (EES).

21-42. (canceled)

43. An edge server, comprising:
a processor;
a transceiver coupled to the processor; and
a memory having stored thereon executable instructions that, when be loaded and executed by the processor, cause the edge server to implement actions comprising:
receiving an authentication method request sent by a terminal, the authentication method request being configured to request to select any one authentication method from n authentication methods; and
sending a first response message to the terminal in response to the authentication method request, the first response message comprising a target authentication method selected from the n authentication methods, n being a positive integer.

44-45. (canceled)
